(19) United States
(12) Patent Application Publication
(10) Pub. No.: US 2012/0263234 A1
(43) Pub. Date: Oct. 18, 2012

(54) Data Processing Method and Digital Image Processing Device for Reducing Blocking Effect

(76) Inventors: Hsiao-Enmr Chang, Hsinchu City (TW); Jian-De Jiang, Xian (CN); I-Feng Lin, Hsinchu County (TW)

(21) Appl. No.: 13/443,905

(22) Filed: Apr. 11, 2012

(30) Foreign Application Priority Data
Apr. 14, 2011 (TW) 100112946

(51) Int. Cl. H04N 7/26

(52) U.S. Cl. 375/240.14; 375/E07.108

(57) ABSTRACT

A data processing method for a digital image processing device includes: acquiring an the intra-coded frame data and a predicted frame data; acquiring a first pixel value corresponding to a pixel in the intra-coded frame data; acquiring a second pixel value corresponding to the pixel in the predicted frame data; determining a third pixel value according to a first motion vector corresponding to the pixel in the intra-coded frame data and the first pixel value; determining a fourth pixel value according to a second motion vector corresponding to the pixel in the predicted frame data and the second pixel value; calculating an average of the first pixel value and the second pixel value, and accordingly generating a fifth pixel value; and determining a pixel value corresponding to the pixel in an interpolated frame data according to the third pixel value, the fourth pixel value and the fifth pixel value.

### BACKGROUND OF THE INVENTION

1. Field of the Invention

The present invention relates to a data processing method and digital image processing device, and more particularly, to a data processing method and digital image processing device capable of reducing blocking effect.

2. Description of the Prior Art

Along with advance of science and technology, digital image processing is continuously evolving to its sophistication. The basic unit of a digital film is a frame, which can be roughly categorized into two sorts according to different compression manners employed. One is a predicted frame which requires adjacent frame data to act as reference, and only stores the difference between a current frame and the referenced frame to achieve data compression. The other is an intra-coded frame which is independent of the adjacent frames, and therefore has to store all the data required to display the current frame. In other words, the predicted frames can be decoded by referring to the intra-coded frames or other predicted frame(s).

As to the predicted frame, to fully utilize adjacent frame data for reducing the data amount of the stored predicted frame, the predicted frame needs to record corresponding motion status (i.e., motion vectors) in the adjacent frame. The way to do it is first dividing a predicted frame into a number of small blocks, wherein the size of each block can be adjusted according to actual design requirement. Next, the adjacent frame is searched for a corresponding block. At this moment, a displacement between an original block and its corresponding counterpart is the motion vector of the original block. In this way, blocks in the predicted frame can be “predicted” one-by-one via motion vectors according to the adjacent frames. Due to consideration of the performance, when searching for a corresponding block, the conventional design can only search for the most similar block. Thus, there may be image discontinuity between a predicted block found via the motion vector and adjacent blocks, causing mosaic-like blocks in the displayed frame, which is called the blocking effect. In addition, based on the Fourier theorem, there are a number of patterns in an intra-coded frame, each of which can be expressed by a number of superposed cosine functions. Therefore, a compression method usually divides a frame into a number of small blocks first, and then respectively performs discrete cosine transform (DCT) upon each of the small blocks, in order to transform the patterns in the original frame into coefficients in the frequency domain for storage. Since the coefficient data in the frequency domain is far less than the pattern data, the goal of data compression can be achieved. Besides, partial low-frequency data may be discarded to gain a better compression ratio. However, due to the nature of discreteness and discard of partial low-frequency data, a block decoded by a decoder may not be entirely the same as the original block, resulting in a slight blocking effect.

Since the conventional digital image processing device performs a frame rate conversion function by using a duplicate of a predicted frame as an interpolated frame inserted between the original predicted frame and the intra-coded frame, the original blocking effect remains intact after the frame rate conversion is performed, thus degrading the viewing experience of the user. In the prior art, some more sophisticated frame rate conversion techniques further utilize motion vectors for applying linear compensation upon image variation regions after inserting the interpolated frame, to thereby increase fluency in the video playback; however, the conventional linear compensation provides no help to reducing the blocking effect.

In short, digital films which are compressed by conventional digital image processing techniques often suffer from blocking effects. Thus, there is a need for an improved digital image processing technique.

### SUMMARY OF THE INVENTION

Therefore, a primary objective of the present invention is to provide a data processing method and digital image processing device capable of reducing blocking effects in interpolated frames generated by frame rate conversion.

According to one aspect of the present invention, an exemplary data processing method for digital image processing is disclosed. The exemplary method includes acquiring an the intra-coded frame data and a predicted frame data; acquiring a first pixel value corresponding to a pixel in the intra-coded frame data; acquiring a second pixel value corresponding to the pixel in the predicted frame data; determining a third pixel value according to a first motion vector corresponding to the pixel in the intra-coded frame data and the first pixel value; determining a fourth pixel value according to a second motion vector corresponding to the pixel in the predicted frame data and the second pixel value; calculating an average of the first pixel value and the second pixel value, and accordingly generating a fifth pixel value; and determining a pixel value corresponding to the pixel in an interpolated frame data according to the third pixel value, the fourth pixel value and the fifth pixel value.

According to another aspect of the present invention, an exemplary digital image processing device is disclosed. The exemplary device includes a central processing unit (CPU) and a memory. The memory is used for storing a program code, which instructs the CPU to execute following steps: acquiring an the intra-coded frame data and a predicted frame data; acquiring a first pixel value corresponding to a pixel in the intra-coded frame data; acquiring a second pixel value corresponding to the pixel in the predicted frame data; determining a third pixel value according to a first motion vector corresponding to the pixel in the intra-coded frame data and the first pixel value; determining a fourth pixel value according to a second motion vector corresponding to the pixel in the predicted frame data and the second pixel value; calculating an average of the first pixel value and the second pixel value, and accordingly generating a fifth pixel value; and determining a pixel value corresponding to the pixel in an interpolated frame data according to the third pixel value, the fourth pixel value and the fifth pixel value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a data processing method according to an embodiment of the present invention.

FIG. 2 illustrates relative positions of pixels having pixel values determined by the data processing method.

FIG. 3 is a schematic diagram of a related hardware structure which employs the data processing method.

### DETAILED DESCRIPTION

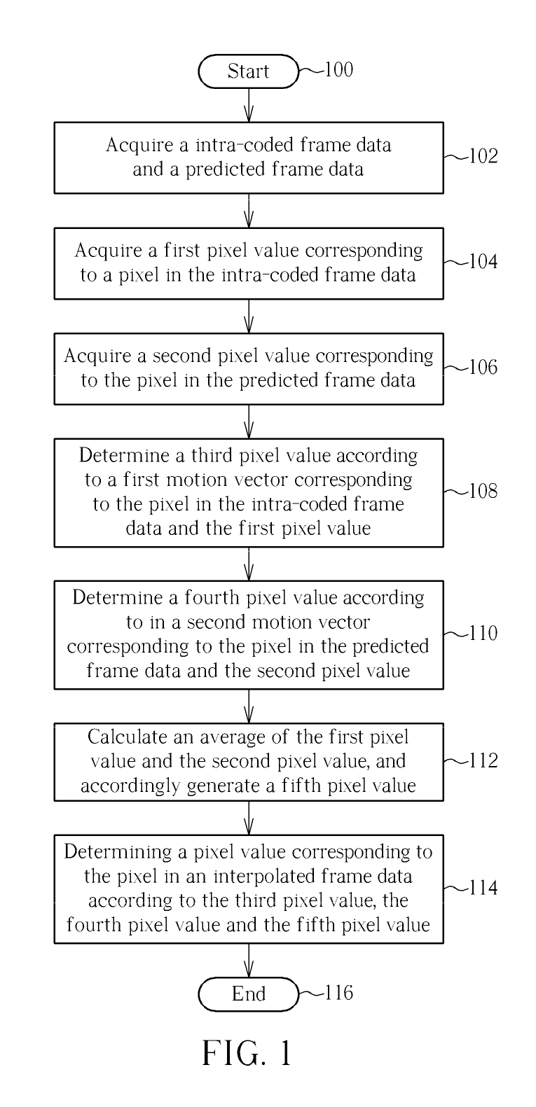

Please refer to FIG. 1, which is a schematic diagram of a data processing method 10 according to an embodiment of the present invention. The data processing method 10 is employed in a digital image processing device. Please note that if the result is substantially the same, steps of the data processing method 10 are not required to be executed in the exact order shown in FIG. 1. The data processing method 10 includes (but is not limited to) the following steps:

Step 100: Start.

Step 102: Acquire an intra-coded frame data and a predicted frame data.

Step 104: Acquire a first pixel value corresponding to a pixel in the intra-coded frame data.

Step 106: Acquire a second pixel value corresponding to the pixel in the predicted frame data.

Step 108: Determine a third pixel value according to a first motion vector corresponding to the pixel in the intra-coded frame data and the first pixel value.

Step 110: Determine a fourth pixel value according to a second motion vector corresponding to the pixel in the predicted frame data and the second pixel value.

Step 112: Calculate an average of the first pixel value and the second pixel value, and accordingly generate a fifth pixel value.

Step 114: Determining a pixel value corresponding to the pixel in an interpolated frame data according to the third pixel value, the fourth pixel value and the fifth pixel value.

Step 116: End.

According to the data processing method 10, when the digital image processing device executes a frame rate conversion function, the digital image processing device first acquires an intra-coded frame data I-frame and a predicted frame data P-frame corresponding to an interpolated frame data, and then respectively acquires a first pixel value PV_1 and a second pixel value PV_2 from the intra-coded frame data I-frame and the predicted frame data P-frame according to a specific pixel P_0 in the interpolated frame data, and calculates an arithmetic mean of the first pixel value PV_1 and the second pixel value PV_2 to generate a fifth pixel value PV_5. The data processing method 10 further determines the third pixel value PV_3 according to the first motion vector MV_1 and the first pixel value PV_1 corresponding to the pixel P_0 in the intra-coded frame data I-frame, and determines the fourth pixel value PV_4 according to the second motion vector MV_2 and the second pixel value PV_2 corresponding to the pixel P_0 in the predicted frame data P-frame. Finally, the data processing method 10 determines a pixel value of the pixel P_0 according to a relative magnitude relation of third pixel value PV_3, fourth pixel value PV_4 and fifth pixel value PV_5.

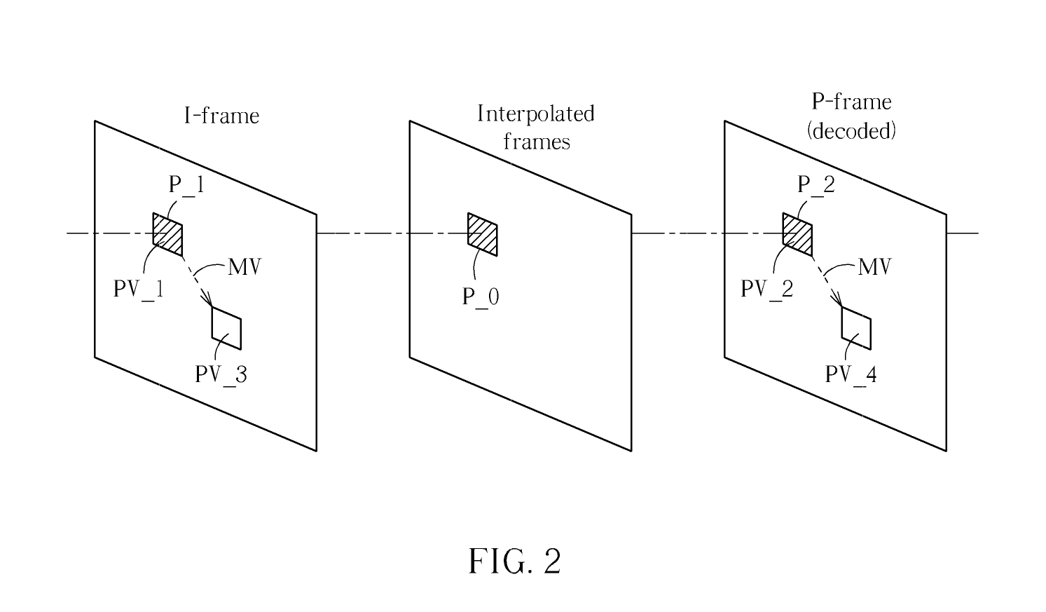

In detail, since the intra-coded frame stores more data and thus has less distortion, the data processing method 10 adopts the intra-coded frame data I-frame in collaboration with the predicted frame data P-frame to determine the interpolated frame data for maintaining the picture quality. Please refer to FIG. 2, which illustrates relative positions of pixels having the pixel values determined by the data processing method 10. The intra-coded frame data I-frame includes the first pixel value PV_1 which corresponds to the pixel P_0 in the interpolated frame data; In the same token, the predicted frame data P-frame includes the second pixel value PV_2 which corresponds to the pixel P_0. An average of the first pixel value PV_1 and the second pixel value PV_2 is the fifth pixel value PV_5 which acts as a reference frame used to determine the pixel value of the pixel P_0. In addition, the intra-coded frame data I-frame further includes the motion vector MV_1 which corresponds to the first pixel value PV_1 and is used for recording relative positions of pixels P_1 and P_0 in the intra-coded frame data I-frame, wherein the third pixel value PV_3 of the pixel P_1 and the first pixel value PV_1 are characteristically similar. The third pixel value PV_3 is used as another reference frame used to determine the pixel value of the pixel P_0. Similarly, the predicted frame data P-frame includes the motion vector MV_2 which corresponds to the second pixel value PV_2 and is used for recording relative positions of pixels P_2 and P_0 in the intra-coded frame data I-frame, wherein the fourth pixel value PV_4 of the pixel P_2 and the first pixel value PV_1 are characteristically similar. The fourth pixel value PV_4 is used as yet another reference frame to determine the pixel value of the pixel P_0. In order to reduce blocking effects in the interpolated frames, the present invention uses a median of the third pixel value PV_3, the fourth pixel value PV_4 and the fifth pixel value PV_5 to determine the pixel value of the pixel P_0 under a normal condition. If the degree of similarity of the fifth pixel value PV_5 and the third pixel value PV_3 is greater than that of the third pixel value PV_3 and the fourth pixel value PV_4, the present invention uses an arithmetic mean of the third pixel value PV_3 and the fourth pixel value PV_4 to determine the pixel value of the pixel P_0. Similarly, if the degree of similarity of the fifth pixel value PV_5 and the fourth pixel value PV_4 is greater than that of the third pixel value PV_3 and the fourth pixel value PV_4, the present invention also uses the arithmetic mean of the third pixel value PV_3 and the fourth pixel value PV_4 to determine the pixel value of the pixel P_0.

In short, since human eyes are more sensitive to object contrasts in a frame, the spirit of the present invention is therefore to compare pixel values of the boundary pixels of the blocks in a frame with corresponding pixel values in adjacent frames. When the pixel values of the boundary pixels are too high or too low, these pixel values are replaced with a median of these pixels. Consequently, it can increase visual blurriness on the boundary pixels, thereby mitigating the blocking effect. In addition, the data processing method 10 according to the present invention further provides a replacement mechanism which uses the arithmetic mean of the third pixel value PV_3 and the fourth pixel value PV_4 to replace the pixel values when a difference between the third pixel value PV_3 and the fourth pixel value PV_4 is relatively small, thus decreasing blurriness of the compensated frame. In this way, a better visual effect is achieved.

Note that, the manner of selecting the corresponding pixel value in the adjacent frame can be properly adjusted according to actual requirement. For example, in order to reduce computation complexity, the first motion vector MV_1 may be replaced by the second motion vector MV_2; however, this is not meant to be a limitation of the present invention. In addition, the number of the predicted frames P-frame and selection sequence of the predicted frames P-frame can also be altered according to different coding schemes of the digital films. Taking a digital film with an MPEG-2 format for example, the selection of the predicted frame P-frame is not limited to the first predicted frame following the intra-coded frame I-frame, and any predicted frame may be selected as long as it is encoded by using the same intra-coded frame as a reference frame. Besides, the number of the selected predicted frames is also not limited to one. In a case where multiple predicted frames are selected and used, these selected predicted frames can be processed by steps 110-114 of the data processing method 10. Furthermore, the aforementioned pixel value may be a luminance value or a chrominance value. This is not meant to be a limitation of the present invention. Those skilled in the art can make alternations and modifications according above description.

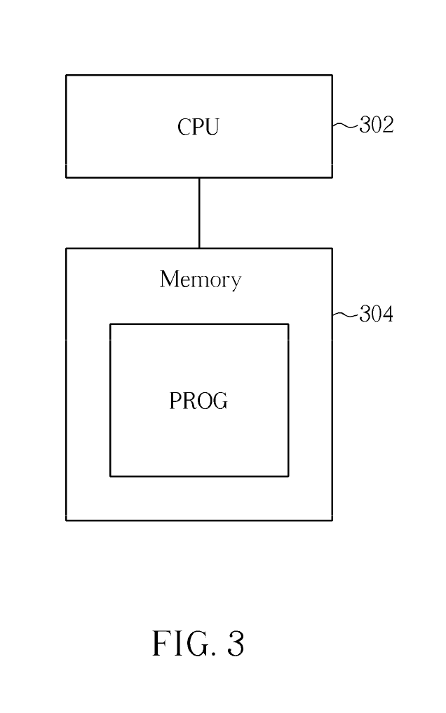

In addition, the actual implementation of each step of the above-mentioned data processing method 10 should be readily understood by those skilled in the art. For example, steps of the data processing method 10 may be compiled into a program code PROG by means of a specific programming language's commands, parameters, variables, etc., and the program code PROG is stored into a memory 304. The program code PROG stored in the memory 304 instructs a central processing unit (CPU) 302 of a related digital image processing device to execute steps of the data processing method 10 when loaded and executed by the CPU 302. Related hardware structure is briefly illustrated in FIG. 3.

In the prior art, when a conventional digital image processing device performs the frame rate conversion function, interpolated frames generated due to frame rate conversion also have blocking effects if the blocking effects are already present in intra-coded frames and predicted frames of a digital film. The user may be unpleasant with such blocking effects and unwilling to use the digital image processing device. Compared to the conventional digital image processing design, the present invention can compensate the interpolated frames when the digital image processing device executes the frame rate conversion function, thereby reducing the blocking effects. Moreover, the present invention provides a replacement mechanism used for decreasing possible blurriness of the compensated frame.

To sum up, by using a median of the corresponding pixel values in adjacent frames to compensate interpolated frames generated in a frame rate conversion process, the present invention can effectively reduce blocking effects. In this way, the video playback smoothness of a digital film is improved, and user's viewing experiences is enhanced accordingly.

Those skilled in the art will readily observe that numerous modifications and alterations of the device and method may be made while retaining the teachings of the invention.

What is claimed is:

1. A data processing method for a digital image processing device, comprising:
acquiring an the intra-coded frame data and a predicted frame data;
acquiring a first pixel value corresponding to a pixel in the intra-coded frame data;
acquiring a second pixel value corresponding to the pixel in the predicted frame data;
determining a third pixel value according to a first motion vector corresponding to the pixel in the intra-coded frame data and the first pixel value;
determining a fourth pixel value according to a second motion vector corresponding to the pixel in the predicted frame data and the second pixel value;
calculating an average of the first pixel value and the second pixel value, and accordingly generating a fifth pixel value; and
determining a pixel value corresponding to the pixel in an interpolated frame data according to the third pixel value, the fourth pixel value and the fifth pixel value.

2. The data processing method of claim 1, wherein the step of determining the pixel value corresponding to the pixel in the interpolated frame data according to the third pixel value, the fourth pixel value and the fifth pixel value comprises:
when a difference between the third pixel value and the fourth pixel value is greater than a difference between the fourth pixel value and the fifth pixel value, and the difference between the third pixel value and the fourth pixel value is greater than a difference of the third pixel value and the fifth pixel value, determining the pixel value corresponding to the pixel in the interpolated frame data to be a median of the third pixel value, the fourth pixel value and the fifth pixel value.

3. The data processing method of claim 1, wherein the step of determining the pixel value corresponding to the pixel in the interpolated frame data according to the third pixel value, the fourth pixel value and the fifth pixel value comprises:
when a difference between the third pixel value and the fourth pixel value is less than a difference between the third pixel value and the fifth pixel value, determining the pixel value corresponding to the pixel in the interpolated frame data to be an arithmetic mean of the third pixel value and the fourth pixel value.

4. The data processing method of claim 1, wherein the step of determining the pixel value corresponding to the pixel in the interpolated frame data according to the third pixel value, the fourth pixel value and the fifth pixel value comprises:
when a difference between the third pixel value and the fourth pixel value is less than a difference between the fourth pixel value and the fifth pixel value, determining the pixel value corresponding to the pixel in the interpolated frame data to be an arithmetic mean of the third pixel value and the fourth pixel value.

5. A digital image processing device, comprising:
a central processing unit (CPU); and
a memory, for storing a program code, the program code instructing the CPU to execute following steps:
acquiring an the intra-coded frame data and a predicted frame data;
acquiring a first pixel value corresponding to a pixel in the intra-coded frame data;
acquiring a second pixel value corresponding to the pixel in the predicted frame data;
determining a third pixel value according to a first motion vector corresponding to the pixel in the intra-coded frame data and the first pixel value;
determining a fourth pixel value according to a second motion vector corresponding to the pixel in the predicted frame data and the second pixel value;
calculating an average of the first pixel value and the second pixel value, and accordingly generating a fifth pixel value; and
determining a pixel value corresponding to the pixel in an interpolated frame data according to the third pixel value, the fourth pixel value and the fifth pixel value.

6. The digital image processing device of claim 5, wherein the step of determining the pixel value corresponding to the pixel in the interpolated frame data according to the third pixel value, the fourth pixel value and the fifth pixel value comprises:
when a difference between the third pixel value and the fourth pixel value is greater than a difference between the fourth pixel value and the fifth pixel value, and the difference between the third pixel value and the fourth pixel value is greater than a difference between the third pixel value and the fifth pixel value, determining the pixel value corresponding to the pixel in the interpolated frame data to be a median of the third pixel value, the fourth pixel value and the fifth pixel value.

7. The digital image processing device of claim 5, wherein the step of determining the pixel value corresponding to the pixel in the interpolated frame data according to the third pixel value, the fourth pixel value and the fifth pixel value comprises:
when a difference between the third pixel value and the fourth pixel value is less than a difference between the third pixel value and the fifth pixel value, determining the pixel value corresponding to the pixel in the interpolated frame data to be an arithmetic mean of the third pixel value and the fourth pixel value.

8. The digital image processing device of claim 5, wherein the step of determining the pixel value corresponding to the pixel in the interpolated frame data according to the third pixel value, the fourth pixel value and the fifth pixel value comprises:
when a difference between the third pixel value and the fourth pixel value is less than a difference between the fourth pixel value and the fifth pixel value, determining the pixel value corresponding to the pixel in the interpolated frame data to be an arithmetic mean of the third pixel value and the fourth pixel value.
